(19) United States
(12) Patent Application Publication
(10) Pub. No.: US 2018/0319072 A1
(43) Pub. Date: Nov. 8, 2018

(54) CUP OR CARTRIDGE

(71) Applicant: Coveris Rigid (Zell) Deutschland GmbH, Zell/Kaimt (DE)

(72) Inventor: Dieter BERGNER, Niedernhall (DE)

(73) Assignee: Coveris Rigid (Zell) Deutschland GmbH, Zell/Kaimt (DE)

(21) Appl. No.: 15/968,040

(22) Filed: May 1, 2018

(30) Foreign Application Priority Data
May 4, 2017 (DE) 10 2017 109 632.9

(51) Int. Cl. B29C 51/08; B29C 51/06; B29C 51/10; B29C 51/26; B29C 51/30

(52) U.S. Cl. CPC B29C 51/08; B29C 51/06; B29C 51/10; B29L 2031/712; B29C 51/306; B29C 2791/001; B29C 2791/006; B29C 51/264

(57) ABSTRACT

Cup or cartridge that is deep-drawn from a plastic film or a plastic cutout has a bottom and a circumferential wall, wherein the deep-drawing contour ensures a predetermined material distribution. A reinforcement, in terms of design, may be provided at the transition between the bottom and the wall. The transition between the bottom and the wall may have an approximately identical or greater material thickness than the bottom or the wall or than both the bottom and the wall.

### CROSS REFERENCE TO RELATED APPLICATIONS

Applicant claims priority under 35 U.S.C. § 119 of German Application No. 10 2017 109 632.9 filed on May 4, 2017, the disclosure of which is incorporated by reference.

### BACKGROUND OF THE INVENTION

### 1. Field of the Invention

The invention relates to a cup or a cartridge that is deep-drawn from a plastic film or a plastic cutout, having a bottom and a circumferential wall.

### 2. Description of the Related Art

Such cups or capsules are often used in coffee machines. Until now, they have been produced either using an injection-molding method or from materials that are questionable with regard to environmental tolerance, such as polystyrene (PS), for example, in order to guarantee sufficient stability and functionality. Previous attempts to produce such cups or cartridges from materials that are easy to recycle, using deep-drawing methods, failed because the cartridges were not stable in terms of shape, in particular when the bottom was being pierced and during brewing.

### SUMMARY OF THE INVENTION

The invention is therefore based on the task of proposing a cup or a cartridge that does not have the aforementioned problems, is stable in shape and easy to pierce.

This task is accomplished, according to the invention, in that the deep-drawing contour ensures a predetermined material distribution.

In this way, undesirable thin spots and thick spots are prevented, and the individual sections have the planned wall thicknesses.

In this connection, it has proven to be very advantageous, according to the invention, if a reinforcement, in terms of design, is provided at the transition between bottom and wall.

As a result, the bottom and, in the case of a corresponding embodiment, also the wall are stabilized, and undesirable bending-in or pushing-in under stress is prevented.

It is likewise very advantageous, according to the invention, if the transition between bottom and wall has an approximately identical or greater material thickness than bottom and/or wall.

As a result, the transition becomes very stable and, above all, prevents the bottom from being pushed in under stress, for example when being pierced in a coffee machine. Furthermore, collapsing of the side wall is prevented.

It is also extremely advantageous if the ratio of the material thickness in the region of the bottom and of the transition region between bottom and wall is 1.0 to greater than 0.75, preferably 1.0 to greater than 0.875.

In the case of such a thickness ratio, the transition region is so solid that it acts as a stabilizing ring.

Furthermore, it is extremely advantageous, according to the invention, if a standing ring is provided at the transition between bottom and wall.

As a result, the cup or the cartridge is reinforced in terms of design. Just like in the case of the transition provided with more material, denting of the bottom during piercing of the bottom is thereby prevented. Under some circumstances, the wall can also be reinforced by this stable ring that is put in place.

Another further development of the invention can be seen in that a rounded-off transition between bottom and wall is provided.

As a result, the cup is improved once again. The wall thicknesses become more uniform. More material can be provided in the rounded part, without this becoming optically noticeable.

According to another further development of the invention, it is also very advantageous if one or more beads is/are provided at the transition between bottom and wall.

Likewise, it is very advantageous, according to the invention, if ribs and/or discrete contours are disposed at the transition between bottom and wall.

By means of both measures, the transition is reinforced and thereby becomes rigid, without requiring any further material. The entire cup is thereby stabilized and has a stable shape even under mechanical stress.

Furthermore, it has proven to be very advantageous if ribs and/or discrete contours are disposed in the region of the wall.

In this way, the wall region is reinforced, in terms of design.

It has also proven to be very advantageous, according to the invention, if the wall thickness varies over the height of the wall.

As a result, material is saved, but nevertheless sufficient stability is ensured at the critical locations. In the case of a wall of a cup that has a height of 45 mm (measured from the bottom), which wall is not reinforced with additional reinforcement elements, a thickness of 380 μm, decreasing to about 260 μm at a height of 5 mm, decreasing again to 200 μm at a height of 20 mm, and increasing again to about 350 μm, in other words directly at the stacking rim, has proven to be very well suitable. Other thickness distributions are conceivable. Such a wall is sufficiently stable to prevent collapsing of the wall under stress. At other cup heights, other height data occur with regard to the distributions.

A further very advantageous embodiment is present if the cup has a circumferential edge at its opening.

As a result, the cup is stabilized, on the one hand, and particularly easy handling is made possible, on the other hand.

In this regard, it has proven to be very advantageous if reinforcement elements, i.e. beads, ribs and/or discrete contours are provided in the region of the transition between wall and edge.

In this way, the transition between wall and edge is also reinforced, in terms of design.

It is also very advantageous if the cup has a stacking rim.

In this way, empty, stacked cups or cartridges can be removed from a stack in particularly simple manner.

According to another very advantageous embodiment of the invention, the bottom of the cup is calibrated with regard to its material thickness, i.e. at least approximately constant, at least in the region that is to be pierced.

In this way, the bottom has uniform mechanical properties in this region. Piercing is facilitated.

It is very advantageous, according to the invention, if the bottom of the cup or of the cartridge has a reinforcement, which is preferably disposed in the center of the bottom.

In this way, the bottom is stabilized once again.

In this regard, it has proven to be particularly advantageous if the bottom of the cup has an elevation that is preferably directed upward, in other words in the direction toward the cup opening.

The elevation stabilizes and reinforces the bottom and can absorb comparatively much material in this regard. As a result, it also becomes possible to reduce the material thickness in the surrounding bottom while maintaining the same stability. Furthermore, in the case of a correspondingly high elevation, the latter can serve as a spacer for a paper filter that rests on the elevation and thereby ensure that the needles do not touch the filter when piercing the bottom.

In this regard, it is very advantageous, according to the invention, if the elevation is configured to be rounded, in the shape of a sphere section, in the shape of a truncated cone, or angular.

The best results were achieved with these shapes.

According to a further embodiment of the invention, it is very advantageous if the bottom that is provided on the outside, around the reinforcement, is configured to be flat.

This flat region is not just flat but can also have a uniform material thickness, so that this region has uniform properties with regard to its ability to be pierced and its strength.

Furthermore, it has proven to be very advantageous, according to the invention, if the bottom has a roughened surface.

As a result, the piercing force, in particular, can be even better adjusted. The roughened surface can be achieved, for example, by means of a correspondingly structured, i.e. roughened deep-drawing mold, which is provided with a laser engraving, for example. It is likewise conceivable that further regions of the cup are additionally or alternatively provided with a roughened surface.

According to a further embodiment of the invention, it is particularly advantageous if the cup bottom can be pierced in defined manner as a whole or in the region around the reinforcement.

Here, the cup or the cartridge can be pierced by needles, for example. When used as a brewing cartridge in coffee machines, a proper brewing process can thereby be ensured.

Furthermore, it is very advantageous, according to the invention, if the cup bottom has a thickness of max. 500 μm, preferably of about 320 to 420 μm, with a deviation of maximally 50 μm, as a whole or in the region around the reinforcement.

This thickness ensures sufficient stability, on the one hand, and furthermore ensures a good ability to be pierced. This is ensured over the entire surface area by the slight deviation.

It is also very advantageous, according to the invention, if the cup is produced essentially from PET, filled PET, i.e. provided with mineral fillers, foamed PET, PP, filled PP, i.e. provided with mineral fillers, and/or foamed PP, and can have barrier layers.

These materials have proven to be particularly advantageous. As a result, a path away from convention PS is opened up. Barrier layers ensure good storage capacity of filled cups or cartridges.

In this regard, it is very advantageous if the cup material has a density of less than 1 in the case of all the PP variants and a density of greater than 1 in the case of all the PET variants.

By means of adherence to these densities, the cup or the cartridge can be separated from other waste very well, and thereby can be recycled very well.

A very advantageous apparatus, according to the invention, for production of a cup according to the invention, exists if a pre-stretcher configured as a punch is provided during production.

Using this pre-stretcher, the material distribution during the deep-drawing process and thereby in the resulting deep-drawn cup can be influenced.

In this regard, it has proven to be very advantageous if the pre-stretcher has a setback in the wall region, preferably in the lower region of the side wall.

By means of the use of such a specially shaped pre-stretcher, it is ensured that during deep-drawing, the desired and required material amount is present in the subsequent corner region of the cup.

Furthermore, it has proven to be very advantageous if the pre-stretcher is configured to have multiple parts.

In this way, the material distribution can be influenced even better.

It is very advantageous, in this regard, if the pre-stretcher consists of an inner part and an outer part.

By means of structuring the pre-stretcher with an inner part and an outer part, it is made possible, during the deep-drawing process, that the inner part is placed ahead of the outer punch (outer part), and thereby the material thickening in the region of the bottom is formed. The remainder of the bottom can thereby be stretched more strongly and configured to be thinner.

A further very advantageous embodiment exists if the pre-stretcher has a calibration surface for calibration of the bottom.

In this way, the deviation of the thickness of the bottom can be reduced once again. The precise configuration of the pre-stretcher for calibration and how the calibration method is carried out are reserved for a separate intellectual property right.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows an illustration of a first variant of the cup according to the invention, with bottom, side wall, edge, and stacking rim,

FIG. 2 shows an illustration of the same cup, seen from below,

FIG. 3 shows a top view of the bottom of the cup,

FIG. 4 shows a vertical section through the cup,

FIG. 5 shows a section through the transition between bottom and side wall of the cup,

FIG. 6 shows a section through the edge and the stacking rim of the cup, wherein the function of the stacking rim is represented,

FIG. 7 shows an illustration of a second variant of the cup according to the invention, with bottom, side wall, edge, and stacking rim,

FIG. 8 shows an illustration of the same cup, seen from below,

FIG. 9 shows a top view of the bottom of the cup,

FIG. 10 shows a vertical section through the cup,

FIG. 11 shows a section through the transition between bottom and side wall of the cup,

FIG. 12 shows a section through the edge and the stacking rim of the cup, wherein the function of the stacking rim is shown, and

FIG. 13 shows a schematic representation of a deep-drawing device having a pre-stretcher, in various stages of the deep-drawing process.

### DETAILED DESCRIPTION OF PREFERRED EMBODIMENTS

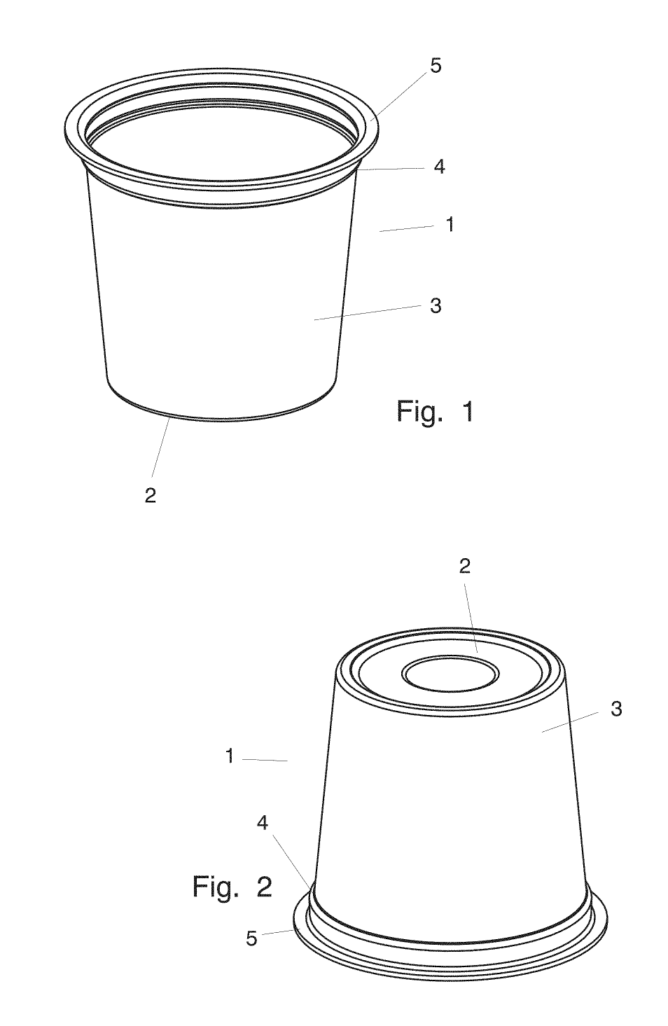

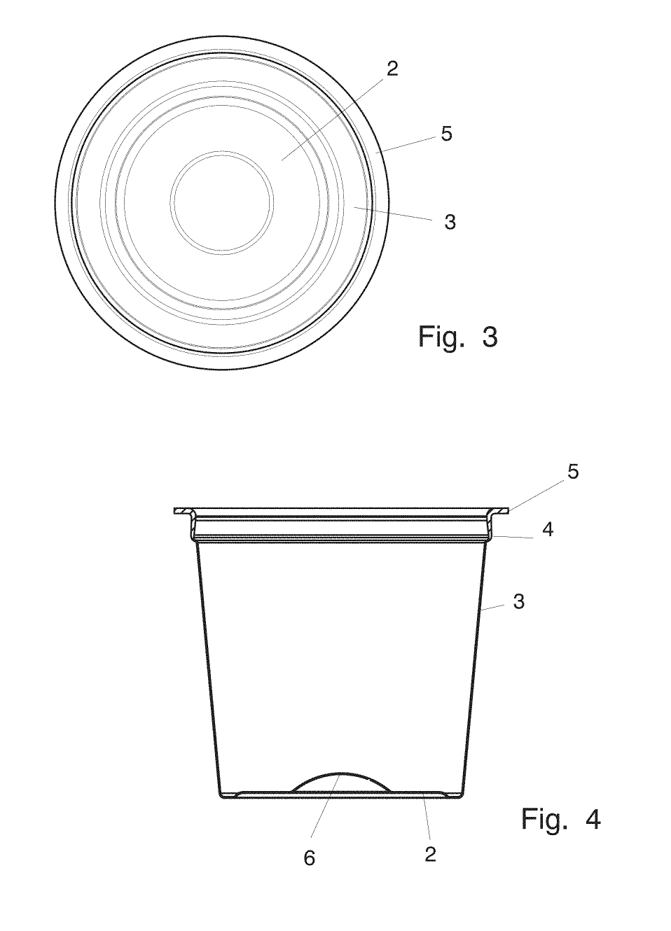

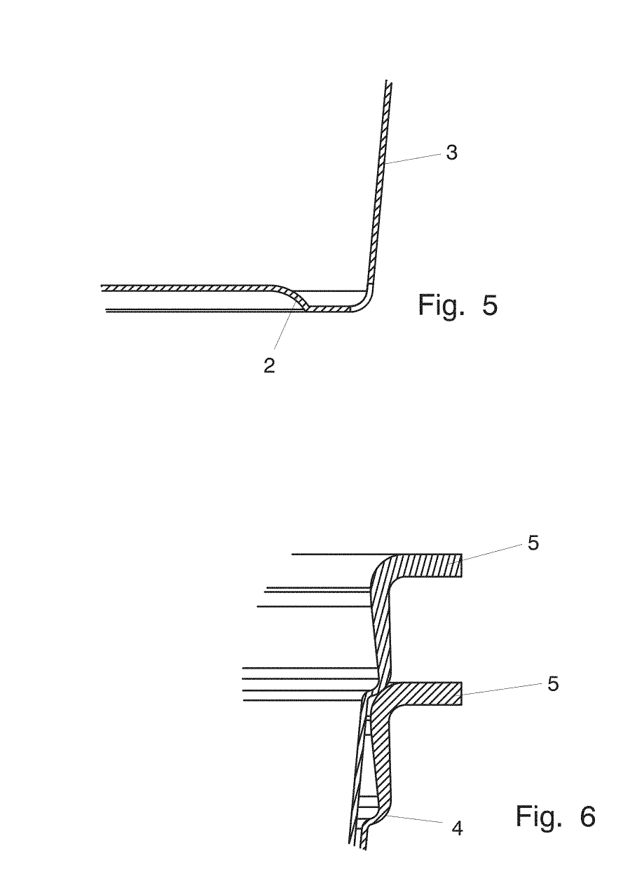

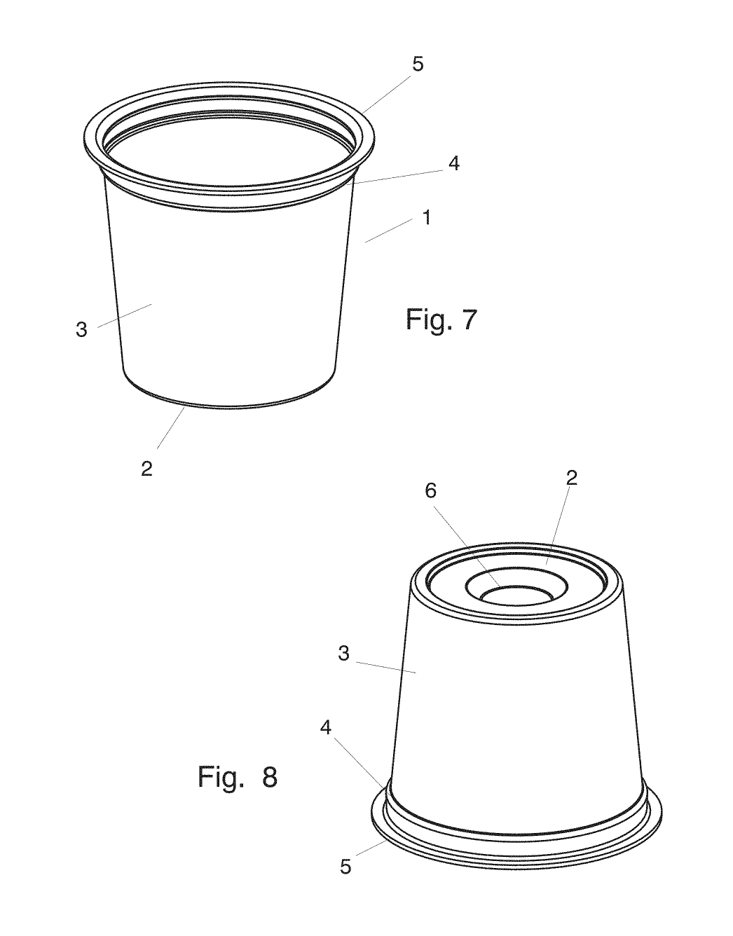

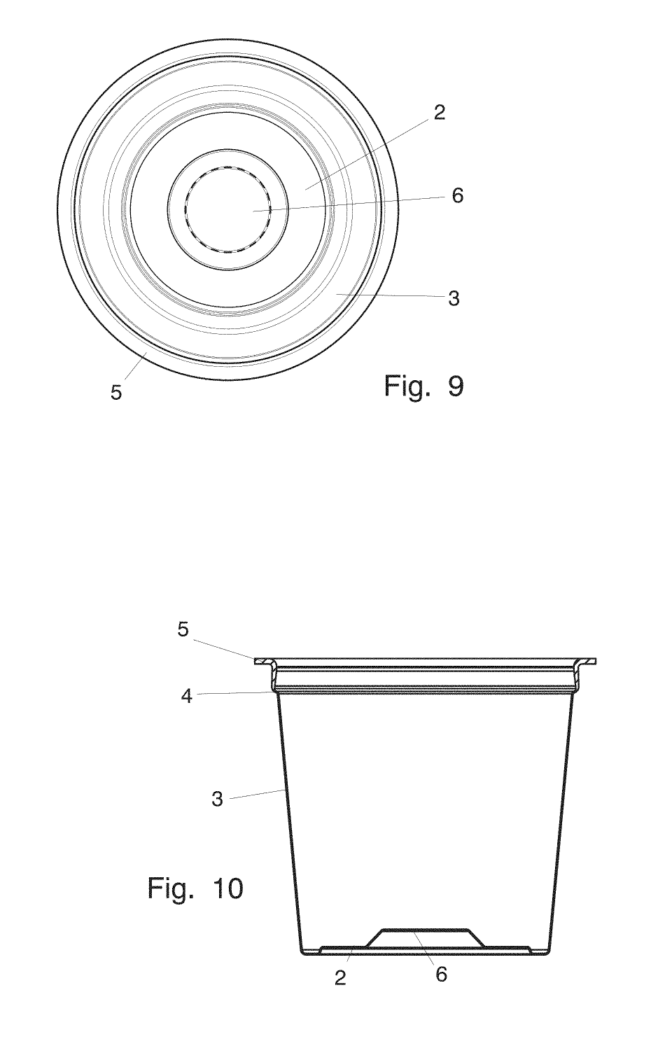

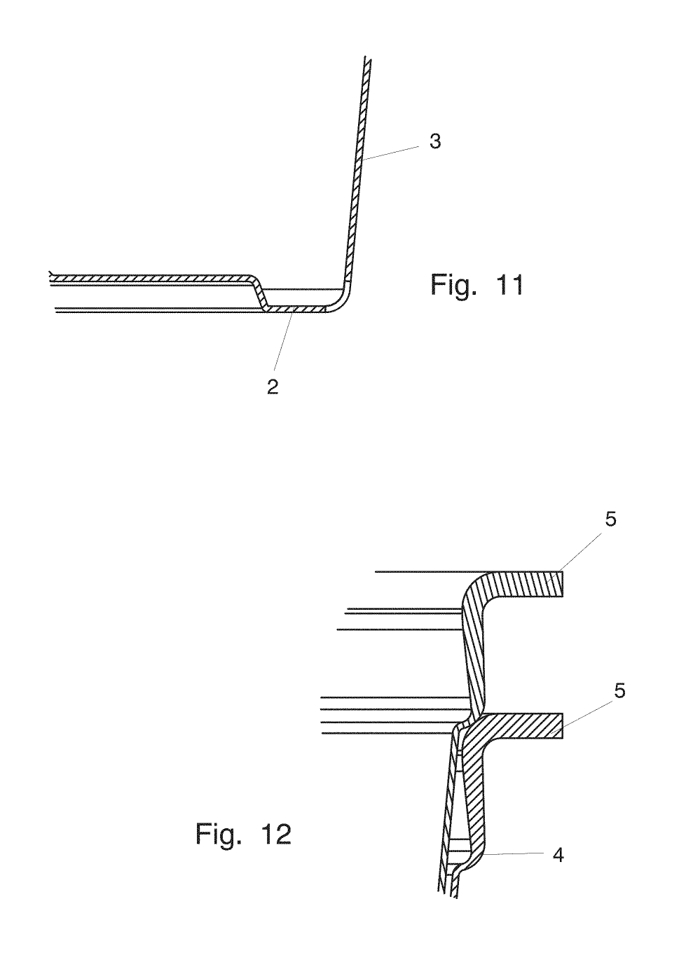

In FIG. 1, 1 refers to a cup having a bottom 2 and a side wall 3 that follows and surrounds the bottom 2. At the end of the side wall 3 that faces away from the bottom 2, a stacking rim 4 that projects outward and a subsequent edge 5, which follows the rim and is directed outward, are provided.

The side wall 3 is inclined slightly outward, proceeding from the bottom 2, wherein angles of inclination in the single-digit degree range, preferably around five degrees have proven to be particularly practicable.

The stacking rim 4 projects outward slightly beyond the wall diameter of the side wall 3 at this location and is part of the side wall 3. Stacking rims 4 in the range of one to two millimeters have proven to be sufficient, but can vary as a function of the size of the cup or of the cartridge, for example.

The stacking rim 4 is followed by the edge 5, which can be configured as a horizontal flange. Edge widths of three to four millimeters are often sufficient so that a lid film, not shown, can be sealed onto the edge 5 in sufficiently tight manner.

In this exemplary embodiment, a radius that produces stability, in terms of design, is provided at the transition between bottom 2 and wall 3.

In addition, in this exemplary embodiment, a lot of material is provided at this transition, so that the transition is also reinforced by the additional material. In this regard, the wall thickness is at least identical to or greater than that of bottom and/or wall. The transition forms a ring that spans and thereby stabilizes the bottom, and makes it non-sensitive with regard to mechanical stresses. Furthermore, collapse of the side wall under stress is prevented by means of this ring.

However, it is also conceivable that beads, bulges or also discrete contours are provided, which, due to their three-dimensional configuration, reinforce not only the transition between bottom 2 and wall 3, but also the bottom 2 and the wall 3.

In addition or alternatively, further reinforcement elements such as ribs, beads or discrete contours can be disposed in the bottom 2 and/or in the wall 3.

Likewise, reinforcement elements between the wall 3 and the edge flange 5 are conceivable. In this regard, these can also include the stacking rim 4 or pass through it.

It is conceivable that, as shown in this exemplary embodiment, an elevation 6, which is configured in the shape of a sphere section here, is provided in the center of the bottom 2. Other shapes are conceivable.

This elevation 6 stabilizes the bottom.

In this regard, the bottom 2 meets the set requirements, for example with regard to stability, piercing behavior or the like.

If the elevation 6 is furthermore provided with a comparatively large amount of material, meeting these requirements can be ensured particularly easily.

Furthermore, in the case of a correspondingly high elevation, the latter can serve as a spacer for a paper filter that rests on the elevation, and thereby ensure that the needles do not touch the filter when they pierce the bottom.

During its production, the bottom 2 can also be calibrated by means of a special apparatus, the details and application of which are not an object of this intellectual property right, so that the bottom 2 has a uniform thickness and uniform properties over its entire surface area, with the exception of the elevation 6.

Part of the special apparatus is a pre-stretcher configured as a punch, which not only influences and ensures the material distribution in the cup, but also can be used for calibration of the bottom.

Therefore the cup 1 is suitable, among other things, also for coffee cartridges or the like, in which the bottom 2 is pierced in a machine during preparation of the coffee. It can be ensured that in this regard, the bottom 2 neither breaks nor is too difficult or actually impossible to pierce. In this regard, the performance of the cup 1 is uniform within the desired specifications. Other applications are conceivable.

In addition, the bottom 2 can also be roughened or provided with a structure. This can introduced by means of an insert in the deep-drawing apparatus, for example, which itself is structured. In this regard, inserts that are provided with a laser engraving are particularly well suitable. Likewise, the pre-stretcher can be correspondingly structured, and produce roughening or structures during calibration.

Particularly good ability of the bottom 2 to be pierced in combination with the desired stability is achieved if the bottom 2 has a thickness of maximally 500 μm, preferably between about 320 and 420 μm, at least in its region around the elevation 6. A slight deviation of maximally 50 μm is particularly practical in this regard.

Particularly in combination with roughening, excellent and uniform ability of the bottom 2 to be pierced is thereby achieved. Furthermore, bending and push-through of the bottom 2 during piercing are prevented by the ring at the transition between bottom 2 and wall 3. Also, the cup 1 is not contracted during this process.

In order to achieve the desired stability of the cup 1, it has proven to be particularly advantageous if the ratio of the material thickness in the bottom 2 and of the transition region between bottom 2 and wall 3 is 1.0 to greater than 0.75, preferably 1.0 to greater than 0.875. This means that the transition region essentially has a material thickness that is approximately identical to or even greater than that of the bottom 2.

In this way, the desired shape stability during emptying of the cartridge or during production of a desired hot beverage is achieved and ensured. Furthermore, the side wall is protected against undesirable collapse under mechanical stress.

The material thickness of the wall 3 can vary over its height.

As a result, material is saved, but nevertheless sufficient stability is ensured at the critical locations. In the case of a wall 3 of a cup having a height of 45 mm (measured from the bottom), which is not reinforced by additional reinforcement elements, a thickness of 380 μm, for example, dropping to about 260 μm at a height of 5 mm, decreasing again to 200 μm at a height of 20 mm, and increasing again to about 350 μm at a height of 40 mm, in other words directly at the stacking rim 4, has proven to be very well suitable. Other thickness distributions are conceivable. Such a wall 3 is sufficiently stable to prevent collapsing of the wall under stress, for example during piercing of the bottom or also during a brewing process. At other cup heights, other height data occur with regard to the distributions.

The cup 1 is produced from PET, filled PET, i.e. provided with mineral fillers, foamed PET, PP, filled PP, i.e. provided with mineral fillers, and/or foamed PP, wherein the density of the cup material is preferably less than 1 in the case of all the PP variants and greater than 1 in the case of all the PET variants. Due to these densities, the cup can be separated from beverage residues, for example coffee grounds, in a water bath, and also from other plastics, and thereby passed along to sorted recycling. Furthermore, stability is ensured by the use of these materials in combination with the stabilization characteristics in terms of design. It is possible to do without the use of PS or other plastics that do not have a good environmental impact, in part. Furthermore, the use of material as a whole is reduced.

For production, a plastic film or a film section is deep-drawn. In this regard, a pre-stretcher configured as a punch, which is provided with a setback in the wall region, can be used. The setback is preferably disposed in the lower region of the side wall.

The use of such a specially shaped pre-stretcher ensures that the desired and required amount of material is present in the subsequent corner region of the cup during deep-drawing.

In the case of a pre-stretcher configured in multiple parts, the material distribution can be influenced even better.

In this regard, the pre-stretcher can consist of an inner part and an outer part.

By means of the structure of a pre-stretcher having an inner part and an outer part, it becomes possible, during the deep-drawing process, that the inner part is disposed ahead of the outer punch (outer part), and that the material thickening in the region of the bottom is formed in this way. The remainder of the bottom can thereby be stretched more strongly and configured to be thinner.

By means of both embodiments, the material distribution within the deep-drawn cup 1 can be controlled and predetermined even better. Undesirable thin points or thick points are prevented.

Furthermore, it becomes possible to use the pre-stretcher also for calibration of the bottom 2 and/or to produce roughening of the bottom.

For this purpose, the pre-stretcher has a calibration surface for calibration of the bottom.

The deviation of the thickness of the bottom can thereby be reduced once again. The precise embodiment of the pre-stretcher for calibration and for carrying out the calibration method is reserved for a separate intellectual property right.

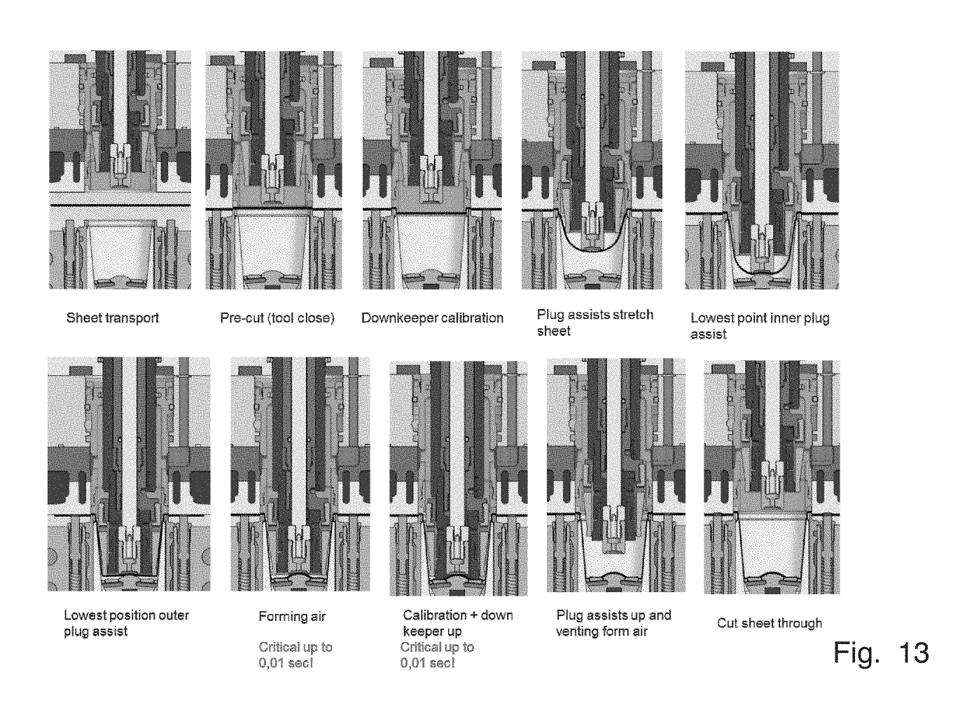

In FIG. 13, a schematic sequence of the deep-drawing process is shown. First, a flat film is introduced between the deep-drawing mold and the pre-stretcher disposed above it.

Subsequently, a down-keeper and a punch move down from the pre-stretcher against the deep-drawing mold and clamp the film in place and cut it off at the outer contour.

Now the pre-stretcher with the inner part situated at the front is moved down into the deep-drawing mold. The inner part impacts the film to be deep-drawn and cools it in this region. This region forms the subsequent reinforcement 6 in the bottom 2.

In this regard, the pre-stretcher moves so far into the deep-drawing mold that the inner part impacts the corresponding contour of the deep-drawing mold.

Now the outer part continues to move in until it lies at approximately the same level as the inner part.

Now the film, which has already been pressed into the mold, is shaped by means of a partial vacuum or excess pressure, so that it comes to lie against the deep-drawing mold.

Afterward, the calibration surface is brought into contact with the bottom of the cup that has been formed. The bottom is calibrated between the calibration surface of the punch and the deep-drawing mold.

Now the pre-stretcher is pulled out of the deep-drawing mold again, and subsequently the cup edge is trimmed, in its entirety.

After unmolding, the process can be started from the beginning once again.

Although only a few embodiments of the present invention have been shown and described, it is to be understood that many changes and modifications may be made thereunto without departing from the spirit and scope of the invention.

1. A cup or a cartridge that is deep-drawn from a plastic film or a plastic cutout, having a bottom and a circumferential wall, wherein the deep-drawing contour ensures a predetermined material distribution.

2. The cup according to claim 1, wherein a reinforcement, in terms of design, is provided at the transition between bottom and wall.

3. The cup according to claim 1, wherein the transition between bottom and wall has an approximately identical or greater material thickness than bottom and/or wall.

4. The cup according to claim 3, wherein the ratio of the material thickness in the region of the bottom and of the transition region between bottom and wall is 1.0 to greater than 0.75, preferably 1.0 to greater than 0.875.

5. The cup according to claim 1, wherein a standing ring is provided at the transition between bottom and wall.

6. The cup according to claim 1, wherein a rounded-off transition between bottom and wall is provided.

7. The cup according to claim 1, wherein one or more beads is/are provided at the transition between bottom and wall.

8. The cup according to claim 1, wherein ribs and/or discrete contours are disposed at the transition between bottom and wall.

9. The cup according to claim 1, wherein ribs and/or discrete contours are disposed in the region of the wall.

10. The cup according to claim 1, wherein the wall thickness varies over the height of the wall.

11. The cup according to claim 1, wherein the cup has a circumferential, flat edge at its opening.

12. The cup according to claim 11, wherein reinforcement elements, i.e. beads, ribs and/or discrete contours are provided in the region of the transition between wall and edge.

13. The cup according to claim 1, wherein the cup has a stacking rim.

14. The cup according to on claim 1, wherein the bottom of the cup is calibrated with regard to its material thickness, i.e. at least approximately constant, at least in the region that is to be pierced.

15. The cup according to claim 1, wherein the bottom of the cup or of the cartridge has a reinforcement that is preferably disposed in the center of the bottom.

16. The cup according to claim 15, wherein the bottom of the cup has an elevation that is preferably directed upward, in other words in the direction toward the cup opening.

17. The cup according to claim 16, wherein the elevation is configured to be rounded, in the shape of a sphere section, in the shape of a truncated cone, or angular.

18. The cup according to claim 15, wherein the bottom provided around the reinforcement on the outside is configured to be flat.

19. The cup according to claim 1, wherein the bottom has a roughened surface.

20. The cup according to claim 1, wherein the cup bottom can be pierced in defined manner as a whole or in the region around the reinforcement.

21. The cup according to claim 1, wherein the cup bottom has a thickness of max. 500 μm, preferably of about 320 to 420 μm, with a deviation of maximally 50 μm, as a whole or in the region around the reinforcement.

22. The cup according to claim 1, wherein the cup is produced essentially from PET, filled PET, i.e. provided with mineral fillers, foamed PET, PP, filled PP, i.e. provided with mineral fillers, and/or foamed PP, and can have barrier layers.

23. The cup according to claim 1, wherein the cup material has a density of less than 1 in the case of all the PP variants and a density of greater than 1 in the case of all the PET variants.

24. An apparatus for the production of a cup according to claim 1, wherein a pre-stretcher, which is configured as a punch, is provided.

25. The apparatus according to claim 24, wherein the pre-stretcher has a setback in the wall region, preferably in the lower region of the side wall.

26. The apparatus according to claim 24, wherein the pre-stretcher is configured in multiple parts.

27. The apparatus according to claim 26, wherein the pre-stretcher comprises an inner part and of an outer part.

28. The apparatus according to claim 24, wherein the pre-stretcher has a calibration surface for calibration of the bottom.
